(19) United States
(12) Patent Application Publication
(10) Pub. No.: US 2016/0117751 A1
(43) Pub. Date: Apr. 28, 2016

(54) ALGORITHM FOR USER INTERFACE BACKGROUND SELECTION

(71) Applicant: VISA INTERNATIONAL SERVICE ASSOCIATION, San Francisco, CA (US)

(72) Inventors: Gregory Tariff, San Francisco, CA (US); Sang Wook Lee, San Francisco, CA (US)

(21) Appl. No.: 14/921,952

(22) Filed: Oct. 23, 2015

Related U.S. Application Data
(60) Provisional application No. 62/067,844, filed on Oct. 23, 2014.

(51) Int. Cl. G06Q 30/06; G06F 3/0484

(52) U.S. Cl. CPC G06Q 30/0625; G06F 3/04842; G06Q 30/0643

(57) ABSTRACT

A system and method may be configured to determine at least one attribute of an item, determine a plurality of images having at least one related attribute, and determine a score for each of the images based on the at least one determined attribute and the at least one related attribute. The system and method may further select one of the images for use as a user interface background based on the scores, and cause a user device to display the selected image as the user interface background.

### CROSS REFERENCE TO RELATED APPLICATIONS

This application claims the benefit of, and priority to, U.S. Prov. Appl. No. 62/067,844 filed Oct. 23, 2014, entitled “Algorithm for User Interface Background Selection,” the entire content of which is incorporated herein by reference.

### BACKGROUND

Electronic commerce is becoming increasingly common. As consumers buy more goods and services online, traditional approaches to gain attention of consumers are not as effective. For example, in store displays near check out registers have traditionally been an effective way to sell goods. However, as fewer people check out in stores, in store displays near check out registers have become less effective.

### SUMMARY

The following presents a simplified summary of the present disclosure in order to provide a basic understanding of some aspects of the disclosure. This summary is not an extensive overview of the disclosure. It is not intended to identify key or critical elements of the disclosure or to delineate the scope of the disclosure. The following summary merely presents some concepts of the disclosure in a simplified form as a prelude to the more detailed description provided below.

A system and method for creating a user interface related to the searches or purchases of a user is described. A computing system may be physically configured for performing an algorithm for determining at least one attribute of an item, determining a plurality of images having at least one related attribute, and determining a score for each of the images based on the at least one determined attribute and the at least one related attribute. The algorithm may further select one of the images for use as a user interface background based on the scores, and cause a user device to display the selected image as the user interface background.

### BRIEF DESCRIPTION OF THE DRAWINGS

The invention may be better understood by references to the detailed description when considered in connection with the accompanying drawings. The components in the figures are not necessarily to scale, emphasis instead being placed upon illustrating the principles of the invention. In the figures, like reference numerals designate corresponding parts throughout the different views.

FIG. 1 may be steps that are performed by a processor physically configured to execute the steps;

FIG. 2 may be a sample user interface;

FIG. 3 may be an additional user interface with a new background;

FIG. 4 may be a network map;

FIG. 5 may be a mobile processor device; and

FIG. 6 may be a server device.

### DESCRIPTION

In accordance with the provisions of the patent statutes and jurisprudence, exemplary configurations described above are considered to represent a preferred embodiment of the invention. However, it should be noted that the invention can be practiced otherwise than as specifically illustrated and described without departing from its spirit or scope.

At a high level, the described system and method may enable merchants to better connect with consumers. The system and method may use intelligence such as from an algorithm to review potential purchases or inquiries from a consumer input via an online search engine to determine attributes of the potential purchases and to select to display a background or take an action that is related to the attributes. Attributes may be as simple as determining whether a good is for a male or a female or may be as complex as analyzing a size, color, pattern, name and cost to determine a useful background or action. As a result, backgrounds may be displayed or actions taken that consumers may find helpful or complementary and merchants may be able to communicate a message to consumers in a non-intrusive way.

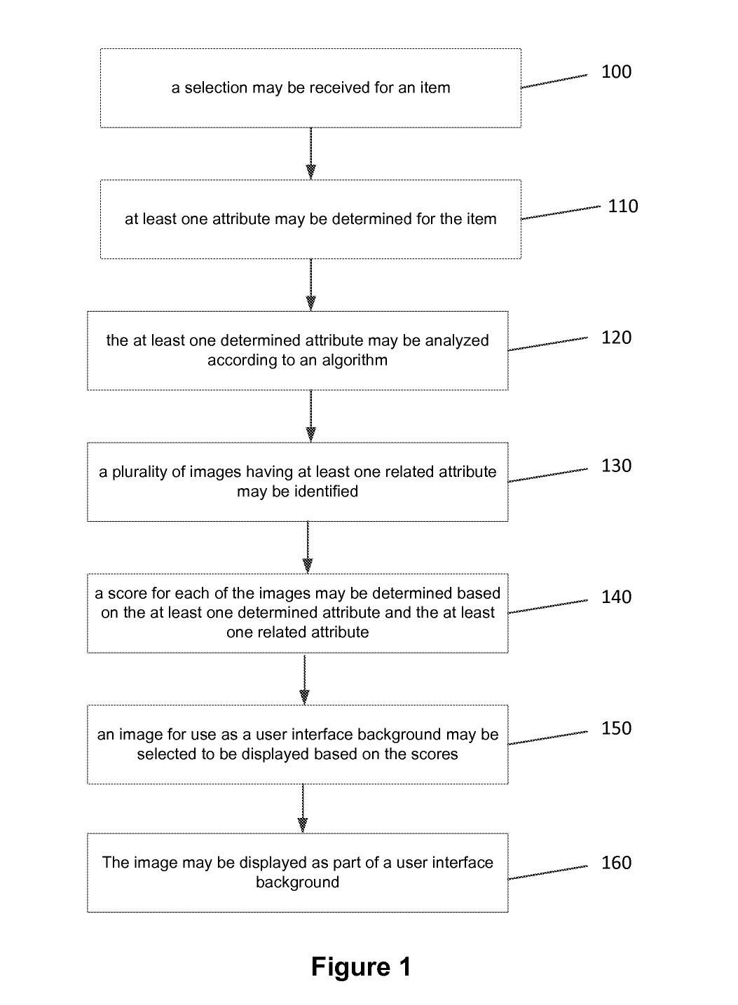

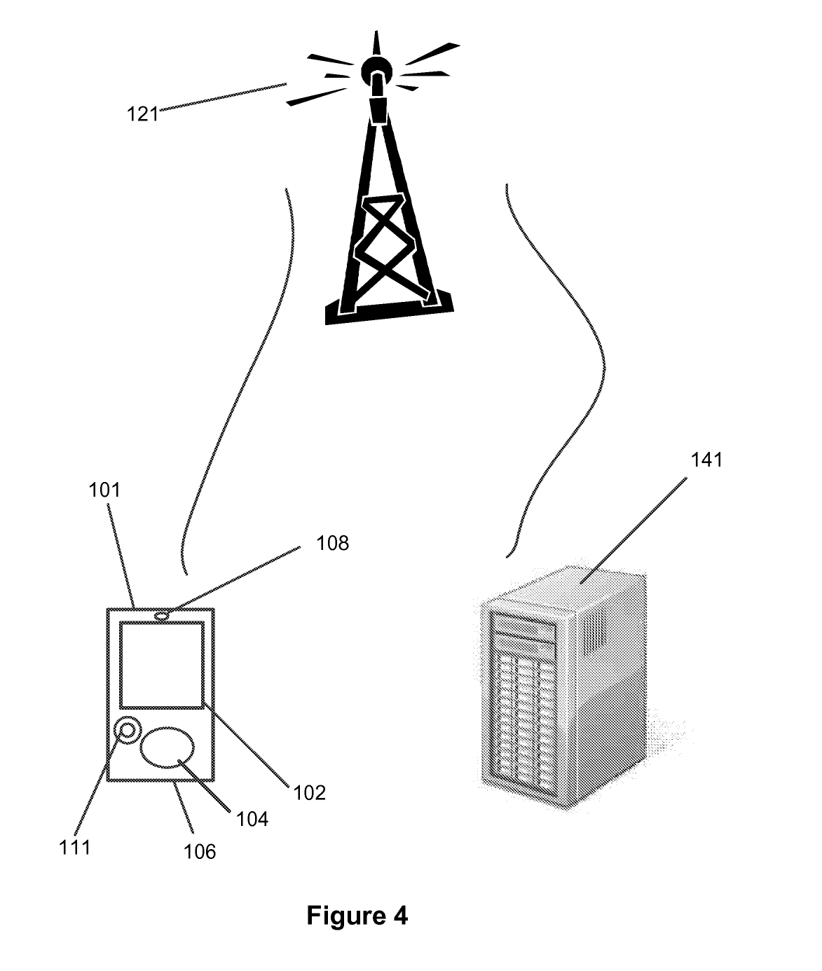

FIG. 1 may illustrate a sample computer implemented method or algorithm for creating an image to be used as a graphical user interface background that may be implemented by a computing system such as the computing system described in FIGS. 4-6. A user device 101 or a server 141, or a combination of device 101 and server 141, may perform the algorithm. The user device 101 may be a computer, a smartphone, a tablet computer, and the like. The functions described herein may be stored as computer-executable instructions that may be executed by at least one processor.

At block 100, a selection may be received for an item. The selection may be made in a variety of ways using a user device 101. For example, if a stand-alone computer is used, the selection may be used with a mouse and a click or with a tap on a touch screen. If a tablet or other portable electronic device is used, a touch screen with an input tap may be used as a selection. Further, voice commands may be used to select an item. In addition, technologies such as eye tracking glasses may be combined with control software to select items.

Items may be a good or a service or a combination of goods and services. The items may be good or service that a consumer desires to purchase or just researches. For example, if a user is researching cars via an online search engine, the specific car that is consistently being researched may be considered the item. As another example, eye doctors may be researched online and ophthalmology services may be determined to be the item. As yet another example, the item may be items in a virtual shopping cart which are ready to be purchased online. Logically, the items to be purchased may be a good or a service or a combination of good or services.

At block 110, at least one attribute may be determined for the item. Attributes may include characteristics about an item. Some attributes may be of more interest than other attributes depending on the system and the desires of the system user as will be described further in this document.

The attributes may be determined in a variety of ways. In one embodiment, text associated with or describing an item may be scanned and reviewed for relevant attributes. The algorithm may review the text and may store descriptive words found in the text. For example, if an item is a jersey of a particular football team, the written description likely includes the name of the football team, the size, color and possibly a fabric type along with common words like “the”, “and” “or” etc. The attributes may be stored in a memory or a database for future use.

Attributes may also be determined from the metadata for an image of the item or a search associated with the item. For example, images may have data stored about the image such as a name or other description. In some instances, the metadata may purposely contain attributes which may be used as attributes. In other embodiments, the metadata may be more vague but still may be used as attributes.

Attributes may also be determined by reviewing the item. Referring again to the example of a football uniform, the item may be compared to known images of jerseys to determine a match. If a match is found, the data about the match may be used to determine attributes about the item.

As another example of determining attributes, the item may be reviewed for any identifiable data, such as text, logos, slogans, team logos, color combinations or other identifiable features. Known procedures may be used to identify text in the item. Similarly, techniques may be used to scan the items for slogans, logos, team symbols, color combinations, etc. More specifically, the item may be broken down into smaller blocks and the blocks may be compared to known blocks to determine if there is a match. If the blocks match, the attributes of the known block may be used in the reviewed block. Obviously, an image or item may have more than one block and more than one attribute.

The attributes may be many and varied. Some attributes may be best guesses such as whether a shirt is designed for a male or a female. Some attributes may be easier to determine such as a color or size. Similarly, logos and team related apparel may be recognized and stored as attributes.

If attributes are being determined for an item that has been searched via an online search engine, a search query may be used for determining one or more attributes. For example, if a search query is for “1968 green Ford Mustang 5 speed v8”, the algorithm may determine attributes to include “automobile”, “1968”, “Green”, “Ford Mustang”, “5 speed transmission” and “v8 engine”. Similarly, if a consumer continues to select to view 1968 Mustangs from a broader search, the algorithm may create attributes of “automobile” and “1968 Ford Mustang”. Further, if a user consistently fails to review cars that have more than 100,000 miles, the algorithm may determine that “cars with less than 100,000 miles” is an attribute. The algorithm may determine other factors related to cars as attributes, including, for example, price, color, mileage, cost, age, location, manufacturer, transmission type, options, number of seats, number of cylinders, etc.

The algorithm may also process a user's online shopping habits to determine items for which to determine attributes. In an example, a user may place one or more items into a virtual shopping cart. If attributes are being determined for items that are in a shopping cart, such as before or after a virtual checkout, the algorithm may process a written description to determine one or more attributes of items placed in the cart. As an example, if a consumer has a container of 100 chewable vitamins, the algorithm may determine attributes from a written description of the container instead of or in addition to interpreting an image that contains the image of the vitamin container.

In another example, the algorithm may create a listing of one or more attributes for an item when a user is shopping online. For example, after a user has placed the one or more items in a virtual shopping cart, the user may proceed to make an online payment using the user device 101. When proceeding to checkout, the user device 101 may communicate a purchase request message to the server 141 that identifies the items to be purchased. The server 141 may receive the purchase request message and apply the algorithm to determine one or more attributes for each item being purchased. For example, a user may be purchasing a yellow crew-neck shirt and the algorithm may determine an item type attribute is a shirt, a style attribute is crew-neck, and a color attribute is yellow. In another example, a user may conduct an Internet search using the phrase “blue 1968 Mustang”. The algorithm may identify an item type attribute is car, a year attribute is 1968, and a color attribute is blue. The algorithm may create as many attributes as desired and the number of attributes may depend on a desired granularity of matching.

Attributes for services may be determined in a similar manner. Both words and images of the item may be analyzed and compared to services and images with known attributes and those attributes may be added to the list of attributes for the service.

At block 120, the at least one attribute may be analyzed according to an algorithm. In an example, the attributes may be analyzed to determine if more weight should be given to some attributes over other attributes. Some attributes may be more important to a user than other attributes. Referring again to car, a consumer may refuse to look at any cars that are blue. Thus, the color of the car may be an important attribute even though the car may have a number of attributes. Similarly, if a consumer reviews a significant number of cars and finally decides on one specific car, the attributes for the car that was actually purchased may take importance over attributes of cars that were not purchased.

Logically, the algorithm may have multiple embodiments or a combination of embodiments. In one embodiment, the algorithm may be consumer focused. The attributes given the greatest weight may be the attributes that the consumer searched the most or actually purchased.

In another embodiment, the algorithm may be merchant focused. The merchant may not sell cars but may sell car seats. Thus, attributes related to a car such as transmission type or engine type may not matter to a merchant while the specifics of the car seats that were searched and purchased may be of great importance to this merchant.

In yet another embodiment, the algorithm may be advertising focused. The algorithm may be tailored toward determining attributes of a consumer that matter to an advertiser. For example, if the advertiser wants to sell pretzels, queries and purchases related to food may be given a greater weight than queries and purchases related to soap.

In yet another embodiment, the algorithm may be product or service focused. As searches and purchases may vary depending on whether they are for services or products, the algorithms may be tailored to each. For example, if a customer is searching for hearing aids, the algorithm may increase output audio volume of user device 101 and note that audio volume may be an attribute. Similarly, if a customer is searching for eye glasses for reading, the algorithm may adjust the size of text displayed by the user device 101 and may note that text size may be an attribute as will be explained further.

In addition, the algorithm may use determined attributes to create inferred attributes. Referring again to shopping, if a user is consistently shopping for cribs and car seats, the algorithm may infer that pregnancy may be an inferred attribute. Similarly, if ‘body shop’ and ‘police report’ are being searched, the algorithm may infer that auto insurance may be an inferred attribute. The inference may be based on products that are complimentary. For example, the algorithm may determine what sets of products users buy or search for at the same time.

At block 130, a plurality of images having a related attribute may be identified. A related attribute may be an attribute that has at least some level of similarity with and/or is complimentary to one or more attributes of an item. For example, a related attribute may be the same as an attribute of an item (e.g., both have a color attribute of blue). A synonym of an attribute of an item may also be considered to be a related attribute. Similar to the determined attributes of block 120, a related attribute may be related to the consumer, to the merchant, to an advertiser or toward the product or service. In an example, there may be a limited number of backgrounds having one or more related attributes. For example, a background with the related attribute of “Ford Mustangs” may be perfect for a consumer with the attributes of “1968 Ford Mustang”. Other backgrounds may have different related attributes such as “soccer gear” “Halloween costumes” or “cable cars.”

In an example, server 141 may include an image database that stores images that each may be used as a background. Each image may have associated metadata about the image identifying at least one attribute of what is depicted in the image. The algorithm may determine what attributes are considered to be related and may query the image database for images having at least one related attribute. Continuing the 1968 mustang example provided above, the algorithm may determine that an item has a type attribute of car, a year attribute of 1968, and a color attribute of blue. The algorithm may determine that “automobile”, “car”, and the years 1960-1969 are related attributes. The algorithm may query a database searching for images having one or more of the related attributes.

At block 140, a score for each of the identified images may be determined based on the at least one determine attribute and the at least one related attribute. In an example, the algorithm may determine a score for indicating how well one or more related attributes of each image correspond to the one or more determined attributes of an item. The algorithm may proceed attribute by attribute for comparing each determined attribute of an item to a related attribute of an image. The algorithm may note whether a particular image does not have one or more attributes of the item.

In some instances, a related attribute and a determined attribute may be a perfect match such where a consumer was searching for a “1968 Mustang” and a background has the related attribute of a “1968 Mustang”. In other embodiments, weights from the attributes may be used to determine the most logical related attribute to use. For example, a 1968 Dodge may be the color of Purple Passion but the color may not be important and may not be a decent match to a perfume with the related attribute of “passion”. A better match may be to the related attribute of muscle cars.

In an example, the algorithm may generate a score based on how well the one or more related attributes of each identified image matches the one or more determined attributes of the item. For example, the algorithm assign a numerical value to each determined attribute of an item and determine a score for an image based on the image how well its related attribute(s) matches the determined attribute(s). For example, an item may have the following determined attributes: a type attribute of “car”, a year attribute of “1968”, and a color attribute of “blue”. The algorithm may determine the following related attributes: a type attribute of “car” or “automobile”, a year attribute being any of 1960-1969, and a color attribute of “blue”.

The algorithm may award points to each of the identified images in the following manner: a type attribute being “car” may be 25 points, a type attribute being “automobile” may be 10 points, a year attribute being “1968” may be 15 points, a year attribute being any of 1960-1967 or 1969 may be 5 points, and a color attribute being blue may be 5 points. For an image of a blue car with an unknown year, the algorithm may determine a score of 30 (e.g., 25 points for type attribute being car and 5 points for the color attribute being blue). For an image of a blue house built in 1968, the algorithm may determine a score of 20 (e.g., 10 points for type attribute being a car and 5 points for the color attribute being blue).

In other embodiments, the algorithm may apply a weighting scheme to the score to generate a weighted score. In an example, the algorithm may apply a multiplier if all of the related attributes of an image are the same as the determined attributes of an item. For instance, for an image of a blue car of the model year 1968, the algorithm may determine a score of 40 and multiply the score by a multiplier (e.g., 1.5) to determining a weighted score of 60 (e.g., 40*1.5). As mentioned previously, the operator of the system may weight the attributes. If the consumer is using the system, the weights may not be skewed. If the merchant is operating the system, the weights may be skewed to favor images of items available for purchase from the merchant. If the system is used for an advertiser, the weights may be skewed toward the advertiser's products.

At block 150, an image for use as a user interface background may be selected to be displayed from block 140. The algorithm may select the image having the highest score. If two or more images have the same score, the algorithm may randomly pick one, may use each of the images in the user interface, or may use some other tie-breaker.

At block 160, the image may be displayed as part of a user interface background. In an example, the algorithm may communicate the image to a user device 101 for display to the user. The image may be scaled to cover some or all of a display screen of the user device 101. In another example, the image may arranged in tiles thus having the user interface background showing multiple copies of the image.

The image selected as the selected user interface may be as simple as displaying blue when a “male” related product is being purchased and displaying pink when a “female” related product is being purchased. In other embodiments, the selected image to be used as a background may be more sophisticated. As an example, the algorithm may pull elements from a database to create a background image on the fly based on the determined attributes. In other examples, the backgrounds may be of a limited number and the best fit among the limited backgrounds may be selected.

Other elements may also be changed as part or alone as the background. For example, the algorithm may change or start an audio element associated with the selected user interface background. In some embodiments, the audio may relate to the attributes of value to the consumer. As an example, if the consumer is looking at items that relate to San Francisco, the algorithm may retrieve a song that is associated with San Francisco and cause the user device 101 to play the retrieved song. Logically, the audio also may relate to the merchant or to an advertiser, such as an advertising jingle.

Similarly, the selected user interface background may be of a moving image that is related to the attributes. Logically, a user device 101 with increased capabilities may create even more opportunities for additional backgrounds. For example, if a mobile computing device has the ability to provide haptic feedback in the form of vibrations, the feedback may be used as a background notification. Of course, the background may be a combination of feedback forms.

The background also may be adjusted based on the attributes as mentioned previously. If the attributes can be tied to a specific action related to an attribute, the action may be considered a background action. For example, if a person reviews glasses and the attributes indicate that a user is far sighted, the algorithm may cause the user device 101 to increase the size of text in the selected user interface background to make the text easier to read. Similarly, if an attribute is that a consumer consistently enters search queries in French, then the algorithm may cause the user device 101 to display text of the selected user interface background in French, display images related to France, and play music related to France.

In other embodiments, the method of payment may be analyzed and the background may represent the method of payment. For example, if a credit card for Bank A is used, the background may be an image related to Bank A or a jingle related to Bank A.

As mentioned previously, there is flexibility in the scoring algorithm. The different scoring mechanisms may result in different backgrounds being displayed. For example, a female consumer may love 1968 Mustangs. While 1968 Mustangs are usually associated with males, a female background may be used on the purchase display if a female purchases a 1968 Mustang. If there is no match whatsoever between related attributes and determined attributes, a default background may be displayed. The default background also may change in a random manner.

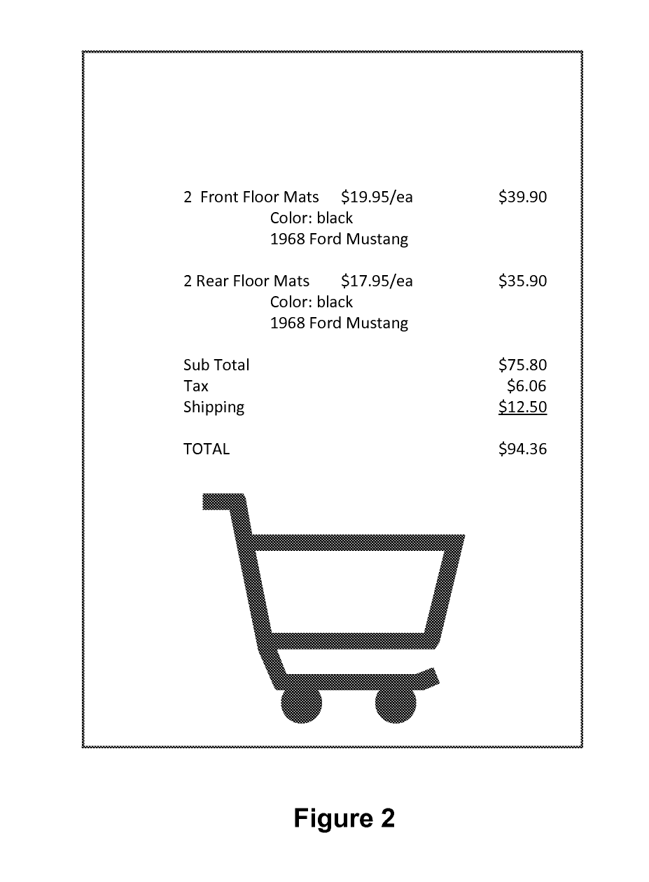

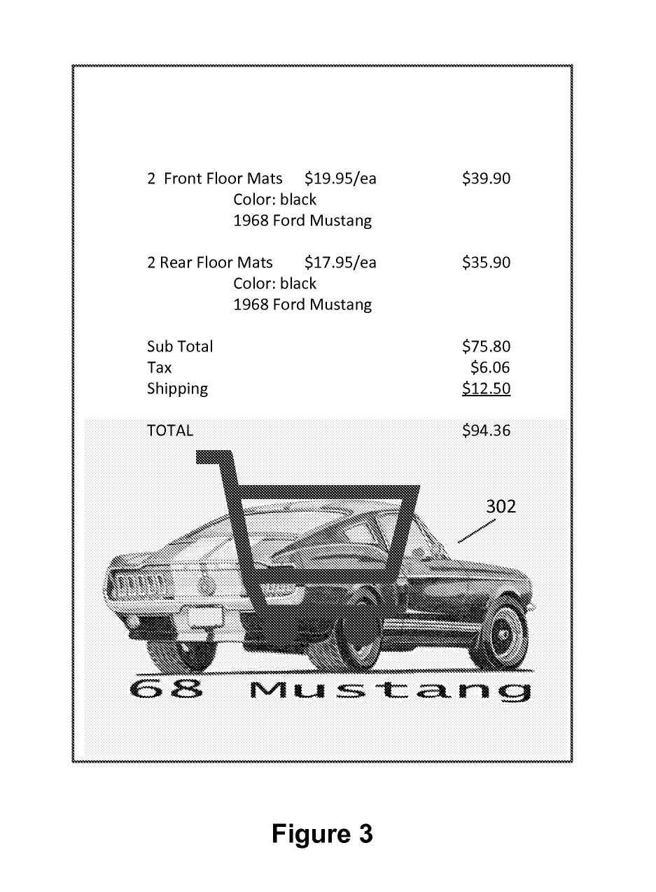

In some embodiments, the algorithm may cause the user device 101 to display the selected user interface background while a consumer is shopping. In another embodiment, the selected user interface background may be displayed when a user is checking out. In yet another embodiment, the selected user interface background may be displayed after a purchase is complete. FIG. 2 may illustrate a traditional checkout display and FIG. 3 may illustrate a checkout display with a background image 302 (a car) selected based on the scoring algorithm. In an example, the user device 101 may cause the background image 302 to appear prior to or after display of the checkout display shown in FIG. 2. For instance, a user may use the user device 101 to select a checkout button presented on a graphical user interface. In response to the selection, the user device 101 may communicate a payment request message to the server 141. The server 141 may perform the algorithm as described in FIG. 1 to determine which image to select. The server 141 may retrieve the selected image and may instruct the user device 101 to display the selected image as a background in a graphical user interface. In some instances, the instruction may be to display the selected user interface as a transition to the checkout display. For example, the user device 101 may display the selected user interface and the selected user interface may fade as the traditional checkout display appears. In other examples, such as depicted in FIG. 3, the user device 101 may simultaneously display the selected user interface and the checkout display. As can be seen, a background of a 1968 Mustang is displayed in FIG. 3 which has attributes which are related to the floor mats which are being purchased by the consumer.

In some instances, the selected image may be associated with a product or service that a user may purchase. For example, the user device 101 may display the selected image that may be selectable and/or have an associated link for purchasing the depicted item depicted in the selected image. For instance, if a user of the user device 101 clicks on the selected image, the user device 101 may automatically add the depicted item to a virtual shopping cart. The algorithm may also track which of the depicted items were added to virtual shopping carts to adjust the scoring algorithm. For example, the scoring algorithm may apply a weighting factor based on the percentage of customers that bought the item depicted in the background. A frequently purchased item may have a positive weighting factor (e.g., 1.25) to increase its weighted score and an infrequently purchased item may have a negative weighting factor (e.g., 0.75) to decrease its weighted score. The algorithm may establish thresholds for determining whether an item is frequently purchased (e.g., at least 10% of users bought a depicted item) or infrequently purchased (e.g., 3% of users or less bought a depicted item). The algorithm may set the weighting factor based on the percentage of users who bought the depicted item. For example, the algorithm may specify a weighting of 1.25 when 25% of users bought a depicted item and may specify a weighting of 1.1 when 10% of users bought a depicted item.

The algorithm may also monitor trends, and emphasize recent purchases and de-emphasis less recent purchases. For example, the algorithm may determine that 15% of users bought a depicted item presented as a background, but that number has increased to 25% over the past week. The algorithm may use the more recent data to set the weighting factor to 1.25 instead of 1.15. Thus, the algorithm may seek to advertise products that customers are more likely to buy.

The system may be intelligent and may improve over time. The system may track how it has matched attributes and determined attributes in the past and determine whether the displayed background was successful. Success may be defined in several ways such as longer time spent on an electronic site, increased sales, additional sales, positive feedback from customers, etc. The system may have goals and may analyze its own performance in an effort to create a better match of attributes and determined attributes in the future. The goals may be set by the user, such as the merchant or the advertiser.

As shown in FIG. 4, the system 100 may include a user device 101, a payment processing server 141, and one or more merchant servers 151 all coupled via a digital communication network 121. The user device 101 generally is any device (i.e., credit card scanners/readers, mobile devices, laptop computers, desktop computers, etc.) that allows a consumer to make a purchase via a payment card account. For example, a consumer may use a traditional physical credit or debit card to conduct a transaction via a card reader. Other examples, include a consumer typing or manually entering the payment card information into a computing device or mobile device. In other embodiments, user devices 101 with near field communication (NFC) or iBeacon capability may be used to communicate the payments transaction data to remote payment processing servers 141. As can be understood, the relevant transaction data may be entered manually or may be communicated in an electronic fashion, such as through a digital communication network 121 and using Wi-Fi, Ethernet, NFC, infrared, tokens, beacons, high frequency communication systems or any other electronic communication format.

It should be noted that the actual account information such as the 16 digit credit card number do not necessarily have to be communicated. A code or token may be used and the code may be used to access the actual payment transaction data which may be stored locally, such as in a user device 101 or may be stored remotely, such as in a cloud payment processing environment 141. Logically, the code may be encrypted and the code may also be used as part of an encryption key.

FIG. 4 may be a high level illustration of a user device 101 communicating with a remote payment processing server 141 through a digital communication network 121 but the application may be stored and accessed in a variety of ways. In addition, the application may be obtained in a variety of ways such as from an app store, from a web site, from a store Wi-Fi system, etc. There may be various versions of the application to take advantage of the benefits of different computing devices, different computing languages and different API platforms.

In one embodiment, a user device 101 may be a device that operates using a portable power source 155 such as a battery (FIG. 2). Referring to FIG. 1, the user device 101 may also have a display 102 which may or may not be a touch sensitive display. More specifically, the display 102 may have a capacitance sensor, for example, that may be used to provide input data to the user device 101. In other embodiments, an input pad 104 such as arrows, scroll wheels, keyboards, etc., may be used to provide inputs to the user device 101. In addition, the user device 101 may have a microphone 106 which may accept and store verbal data, a camera 108 to accept images and a speaker 110 to communicate sounds.

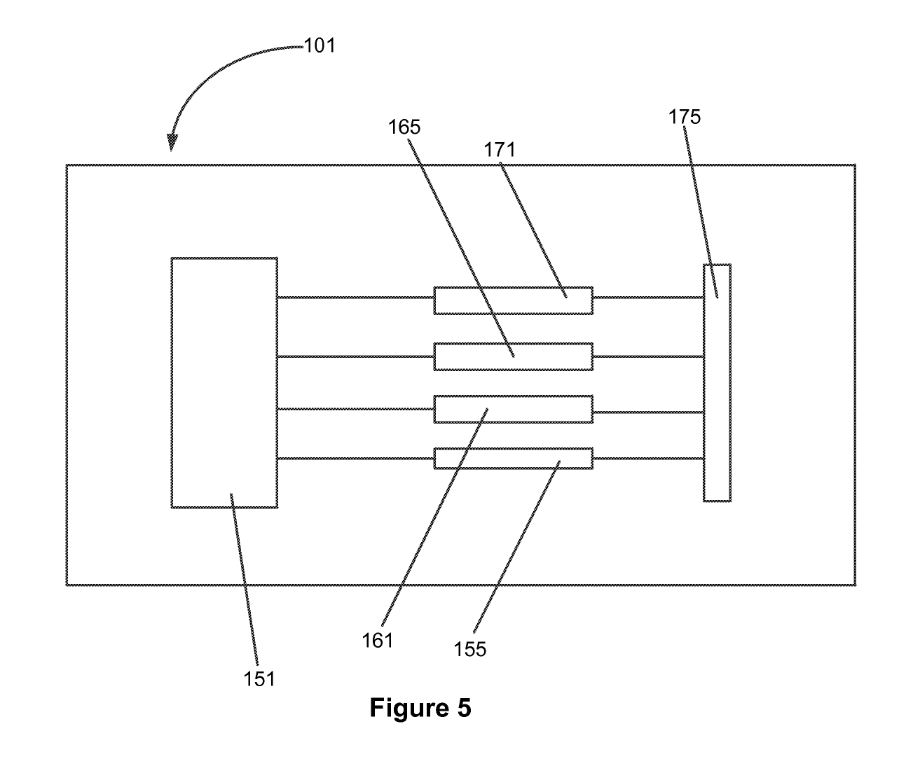

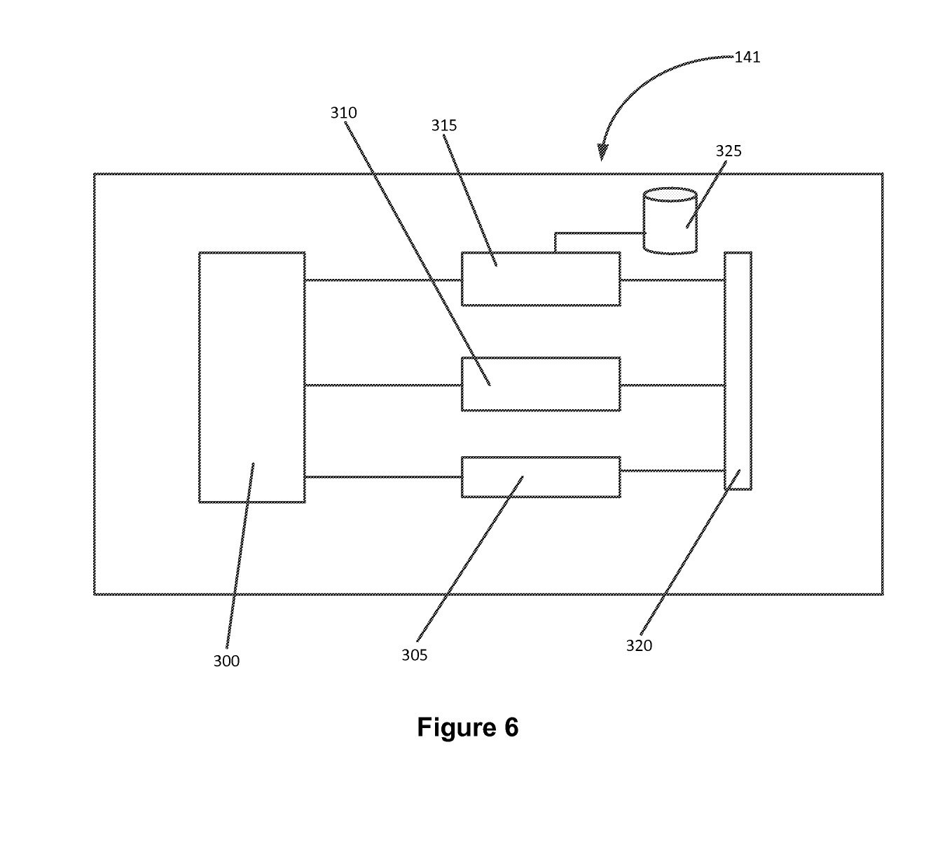

The user device 101 may be able to communicate with a computing device 141 or a plurality of payment processing servers 141 that make up a cloud of computing devices 111 through a digital communication network 121. The user device 101 may be able to communicate in a variety of ways. In some embodiments, the communication may be wired such as through an Ethernet cable, a USB cable or RJ6 cable. In other embodiments, the communication may be wireless such as through Wi-Fi (802.11 standard), Bluetooth, cellular communication or near field communication devices. The communication may be direct to the computing device 141 or may be through a digital communication network 121 such as cellular service, through the Internet, through a private network, through Bluetooth, through near field communications, etc. FIG. 5 may be a simplified illustration of the physical elements that make up a user device 101 and FIG. 6 may be a simplified illustration of the physical elements that make up a payment processing server 141.

Referring to FIG. 5, a sample user device 101 may be physically configured according to a method to be part of the system. The user device 101 may have a processor 150 that is physically configured according to computer executable instructions. It may have a portable power supply 155 such as a battery which may be rechargeable. It may also have a sound and video module 160 which assists in displaying video and sound and may turn off when not in use to conserve power and battery life. The user device 101 may also have volatile memory 165 and non-volatile memory 170. There also may be an input/output bus 175 that shuttles data to and from the various user input devices such as the microphone 106, the camera 108 and other inputs 102, etc. It also may control of communicating with the networks, either through wireless or wired devices. Of course, this is just one embodiment of the user device 101 and the number and types of user devices 101 is limited only by the imagination. The user device 101 may act as the display 102 or may be a part of the display 102.

The physical elements that make up the remote payment processing server 141 may be further illustrated in FIG. 6. At a high level, the payment processing server 141 may include a digital storage such as a magnetic disk, an optical disk, flash storage, non-volatile storage, etc. Structured data may be stored in the digital storage such as in a database. The payment processing server 141 may have a controller 300 (i.e., processor) that is physically configured according to computer executable instructions. It may also have a sound and video module 305 which assists in displaying video and sound and may turn off when not in use to conserve power and battery life. The payment processing server 141 may also have volatile memory 310 and non-volatile memory 315.

The database 325 may be stored in the memory 310 or 315 or may be separate. The database 325 may also be part of a cloud of computing device 141 and may be stored in a distributed manner across a plurality of computing devices 141. There also may be an input/output bus 320 that shuttles data to and from the various user input devices such as the microphone 106, the camera 108, the inputs 102, etc. The input/output bus 320 also may control of communicating with the networks, either through wireless or wired devices. In some embodiments, the application may be on the local computing device 101 and in other embodiments, the application may be remote 141. Of course, this is just one embodiment of the server 141 and the number and types of computing devices 141 is limited only by the imagination.

The database 325 of the payment processing server 141 may store historical transactional data for the one or more users (i.e., consumers) that use their payment card account to purchase goods and services via the system 100. Moreover, the database 325 may store user profiles generated by the processor 300 of the server 141. However, alternatively, the user profiles may be generated by the processor 150 of a user device 101. Regardless, the database 325 may additionally store the data associated any interactive tools, such as questionnaire data, any user feedback data (from a completed questionnaire for example), third party data, and/or any data associated with the proposed offers from the merchant servers 151.

The example embodiments may also provide at least one technical solution to a technical challenge. Conventional systems display backgrounds but do not tailor a background image based on user interests. The example embodiments solve this technical deficiency by determining at least one attribute for one or more items of interest to a user, and select a background based on its score considering the at least one attribute for the one or more items.

The disclosure and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the disclosure. The examples used herein are intended merely to facilitate an understanding of ways in which the disclosure may be practiced and to further enable those of skill in the art to practice the embodiments of the disclosure. Accordingly, the examples and embodiments herein should not be construed as limiting the scope of the disclosure. Moreover, it is noted that like reference numerals represent similar parts throughout the several views of the drawings.

A “computer,” as used in this disclosure, means any machine, device, circuit, component, or module, or any system of machines, devices, circuits, components, modules, etc., which are capable of manipulating data according to one or more instructions, such as, for example, without limitation, a processor, a microprocessor, a central processing unit, a general purpose computer, a super computer, a personal computer, a laptop computer, a palmtop computer, a tablet computer, a smart phone, a notebook computer, a desktop computer, a workstation computer, a server, etc., or an array of processors, microprocessors, central processing units, general purpose computers, super computers, personal computers, laptop computers, palmtop computers, notebook computers, desktop computers, workstation computers, servers, etc.

A “server,” as used in this disclosure, means any combination of software and/or hardware, including at least one application and/or at least one computer to perform services for connected clients as part of a client-server architecture. The at least one server application may include, but is not limited to, for example, an application program that can accept connections to service requests from clients by sending back responses to the clients. The server may be configured to run the at least one application, often under heavy workloads, unattended, for extended periods of time with minimal human direction. The server may include a plurality of computers configured, with the at least one application being divided among the computers depending upon the workload. For example, under light loading, the at least one application can run on a single computer. However, under heavy loading, multiple computers may be required to run the at least one application. The server, or any of its computers, may also be used as a workstation.

A “database,” as used in this disclosure, means any combination of software and/or hardware, including at least one application and/or at least one computer. The database may include a structured collection of records or data organized according to a database model, such as, for example, but not limited to at least one of a relational model, a hierarchical model, a network model or the like. The database may include a database management system application (DBMS) as is known in the art. The at least one application may include, but is not limited to, for example, an application program that can accept connections to service requests from clients by sending back responses to the clients. The database may be configured to run the at least one application, often under heavy workloads, unattended, for extended periods of time with minimal human direction.

A “communication link,” as used in this disclosure, means a wired and/or wireless medium that conveys data or information between at least two points. The wired or wireless medium may include, for example, a metallic conductor link, a radio frequency (RF) communication link, an Infrared (1R) communication link, an optical communication link, or the like, without limitation. The RF communication link may include, for example, Wi-Fi, WiMAX, IEEE 802.11, DECT, OG, IG, 2G, 3G or 4G cellular standards, Bluetooth, and the like.

A “network,” as used in this disclosure means, but is not limited to, for example, at least one of a local area network (LAN), a wide area network (WAN), a storage area network (SAN), a metropolitan area network (MAN), a personal area network (PAN), a campus area network, a corporate area network, a global area network (GAN), a broadband area network (BAN), a cellular network, the Internet, or the like, or any combination of the foregoing, any of which may be configured to communicate data via a wireless and/or a wired communication medium. These networks may run a variety of protocols not limited to TCP/IP, IRC or HTTP.

An “individual” or “consumer” as used in this disclosure means, but is not limited to, for example, a human, artificially intelligent software (e.g., fuzzy logic, neural networks, or the like), a fully automated, robotic entity, or a plurality of fully automated, networked, robotic entities.

The terms “including,” “comprising” and variations thereof, as used in this disclosure, mean “including, but not limited to,” unless expressly specified otherwise.

The terms “a,” “an,” and “the,” as used in this disclosure, means “one or more,” unless expressly specified otherwise.

Devices that are in communication with each other need not be in continuous communication with each other, unless expressly specified otherwise. In addition, devices that are in communication with each other may communicate directly or indirectly through one or more intermediaries.

Although process steps, method steps, algorithms, or the like, may be described in a sequential order, such processes, methods and algorithms may be configured to work in alternate orders. In other words, any sequence or order of steps that may be described does not necessarily indicate a requirement that the steps be performed in that order. The steps of the processes, methods or algorithms described herein may be performed in any order practical. Further, some steps may be performed simultaneously.

When a single device or article is described herein, it will be readily apparent that more than one device or article may be used in place of a single device or article. Similarly, where more than one device or article is described herein, it will be readily apparent that a single device or article may be used in place of the more than one device or article. The functionality or the features of a device may be alternatively embodied by one or more other devices which are not explicitly described as having such functionality or features.

A “computer-readable medium,” as used in this disclosure, means any medium that participates in providing data (for example, instructions) which may be read by a computer. In some examples the computer-readable medium may be non-transitory. Such a medium may take many forms, including non-volatile media, volatile media, and transmission media. Non-volatile media may include, for example, optical or magnetic disks and other persistent memory. Volatile media may include dynamic random access memory (DRAM). Transmission media may include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read. The computer-readable medium may include a “Cloud,” which includes a distribution of files across multiple (e.g., tens of, hundreds of, or thousands of) memory caches on multiple (e.g., tens of, hundreds of, or thousands of) computers.

Various forms of computer readable media may be involved in carrying sequences of instructions to a computer. For example, sequences of instruction (i) may be delivered from a RAM to a processor, (ii) may be carried over a wireless transmission medium, and/or (iii) may be formatted according to numerous formats, standards or protocols, including, for example, Wi-Fi, WiMAX, IEEE 802.11, DECT, OG, I G, 2G, 3G or 4G cellular standards, Bluetooth, or the like.

Certain embodiments are described herein as including logic or a number of components, modules, or mechanisms. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, may comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

Still further, the figures depict preferred embodiments of a system for purposes of illustration only. One skilled in the art will readily recognize from the foregoing discussion that alternative embodiments of the structures and methods illustrated herein may be employed without departing from the principles described herein. Thus, upon reading this disclosure, those of skill in the art will appreciate still additional alternative structural and functional designs for a system through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims

While the disclosure has been described in terms of exemplary embodiments, those skilled in the art will recognize that the disclosure can be practiced with modifications that fall within the spirit and scope of the appended claims. These examples given above are merely illustrative and are not meant to be an exhaustive list of all possible designs, embodiments, applications or modification of the disclosure.

1. A system for selecting an image for use as a user interface background, the system comprising:
at least one processor; and
at least one memory storing computer executable instructions that, when executed, cause the at least one processor to:
determine at least one attribute of an item;
determine a plurality of images having at least one related attribute;
determine a score for each of the images based on the at least one determined attribute and the at least one related attribute;
select one of the images for use as a user interface background based on the scores; and
cause a user device to display the selected image as the user interface background.

2. The system of claim 1, wherein the instructions, when executed, further cause the at least one processor to associate a link with the user interface to enable purchase of a second item depicted in the user interface background.

3. The system of claim 1, wherein the instructions, when executed, further cause the at least one processor to cause the user device to display the user interface background prior to displaying a checkout display for purchasing the item.

4. The system of claim 1, wherein the instructions, when executed, further cause the at least one processor to cause the user device to display the user interface background simultaneously with a checkout display.

5. The system of claim 1, wherein the determining of the at least one attribute is based on input to a search engine.

6. The system of claim 1, wherein the instructions, when executed, further cause the at least one processor to receive a purchase request message identifying the item.

7. The system of claim 6, wherein the determining of the at least one attribute is in response to receiving the purchase request message.

8. A non-transitory computer readable medium storing computer executable instructions that, when executed, cause at least one processor to:
determine at least one attribute of an item;
determine a plurality of images having at least one related attribute;
determine a score for each of the images based on the at least one determined attribute and the at least one related attribute;
select one of the images for use as a user interface background based on the scores; and
cause a user device to display the selected image as the user interface background.

9. The computer readable medium of claim 8, wherein the instructions, when executed, further cause the at least one processor to associate a link with the user interface to enable purchase of a second item depicted in the user interface background.

10. The computer readable medium of claim 8, wherein the instructions, when executed, further cause the at least one processor to cause the user device to display the user interface background prior to displaying a checkout display for purchasing the item.

11. The computer readable medium of claim 8, wherein the instructions, when executed, further cause the at least one processor to cause the user device to display the user interface background simultaneously with a checkout display.

12. The computer readable medium of claim 8, wherein the determining of the at least one attribute is based on input to a search engine.

13. The computer readable medium of claim 8, wherein the instructions, when executed, further cause the at least one processor to receive a purchase request message identifying the item.

14. The computer readable medium of claim 13, wherein the determining of the at least one attribute is in response to receiving the purchase request message.

15. A computer implemented method for creating an image on a user interface comprising:
determining, by at least one processor, at least one attribute of an item;
determining, by the at least one processor, a plurality of images having at least one related attribute;
determining, by the at least one processor, a score for each of the images based on the at least one determined attribute and the at least one related attribute;
selecting one of the images for use as a user interface background based on the scores; and
causing a user device to display the selected image as the user interface background.

16. The method of claim 15, further comprising associating a link with the user interface to enable purchase of a second item depicted in the user interface background.

17. The method of claim 15, further comprising causing the user device to display the user interface background prior to displaying a checkout display for purchasing the item.

18. The method of claim 15, further comprising causing the user device to display the user interface background simultaneously with a checkout display.

19. The method of claim 15, wherein the determining of the at least one attribute is based on input to a search engine.

20. The method of claim 15, further comprising receiving a purchase request message identifying the item, wherein the determining of the at least one attribute is in response to receiving the purchase request message.
